(19) United States
(12) Patent Application Publication
(10) Pub. No.: US 2010/0293764 A1
(43) Pub. Date: Nov. 25, 2010

(54) DISPLAY SYSTEM ARRANGEMENT AND A DISPLY SYSTEM COMPRISING SUCH AN ARRANGEMENT

(75) Inventor: Andreas LUNDGREN, Stockholm (SE)

Correspondence Address: YOUNG & THOMPSON, 209 Madison Street, Suite 500, Alexandria, VA, 22314, US

(73) Assignee: EXPOLINC SOLNA AKTIEBOLAG, Solna (SE)

(21) Appl. No.: 12/773,225

(22) Filed: May 4, 2010

(30) Foreign Application Priority Data
May 20, 2009 (EP) 09446503.6

(51) Int. Cl. B42F 1/00

(52) U.S. Cl. 24/67 R

(57) ABSTRACT

A display system and arrangement for retaining a sheet of material, includes an elongated support profile and at least one retainer profile, the support profile includes a longitudinal channel open towards a lower side of the support profile and which presents a first surface and an opposite second surface, the at least one retainer profile being insertable in the channel to form a retaining interface between the first surface of the channel and a first surface of the retainer profile, the retainer profile including a reverse second surface. The display system includes at least one locking clip insertable in the channel between the second surface of the channel and the second surface of the retainer profile. The locking clip includes spring element, which when inserted exerts pressure in the transverse direction against the second surface of the channel and the second surface of the retainer profile.

### TECHNICAL FIELD OF THE INVENTION

The present invention relates generally to the field of display systems for displaying a message of a sheet of material. Further, the present invention relates specifically to the field of display system arrangements for retaining said sheet of material. The display system arrangement comprises an elongated support profile and at least one retainer profile, the support profile comprises a longitudinal channel, which is open towards a lower side of the support profile and which present a first surface and a the first surface opposite second surface, the at least one retainer profile being insertable in said channel in order to form a retaining interface between said first surface of the channel and a first surface of the retainer profile, the retainer profile comprising a the first surface reverse second surface. The invention also relates to a display system comprising such a display system arrangement.

### BACKGROUND OF THE INVENTION

It is commonly recognized that in order to communicate a company identity, company profile, logotype, product, etc. on fairs, exhibitions, lectures, in shops, etc., different types of portable display systems are easy to use and gives a professional appearance. Display systems are arranged to display a sheet of material, such as a banner, poster, print, or the like, which may be made of a laminated sheet of material, a cardboard or paper sheet of material, or a flexible sheet of material made of fabric or vinyl.

A banner stand and a roll up are two frequently used display systems. In brief the banner stand comprises a stand, a supporting rod, a banner, a top profile and a bottom profile, and the roll up comprises a stand accommodating a cassette with the banner, a supporting rod and a top profile.

The possible use of many different types of sheet of material, which have different surface structure and different thickness, makes it difficult to use the same top profile, which is designed to retain the banner. That is, for instance a banner made of fabric, or a banner made of vinyl having dimples, or a banner having a glossy and/or a very even surface is harder to retain then a banner having a laminated surface. A known way of retaining different types of banners in one and the same top profile is to use several locking screws distributed along the top profile, which locking screws may be tightened as much as needed depending on the banner in question. This known top profile is shown in FIG. 10.

However, during mounting a hole must be drilled in the top profile for each locking screw, the nut must be axially moved to the right position in the support profile, and the locking screw must be tightened by means of a tool. Thus, the mounting of the banner is complicated, time consuming and requires tools. Thus, the known top profile of the display system does not admit easy mounting or change of a banner, which for instance may by required on a fair or exhibition, or in a shop.

Another known display system arrangement is a clamp profile having an eccentric lock design. However, it is difficult to mount the banner in a straight manner and the banner most often gets wrinkles and folds during the fastening operation. In addition this type of display system arrangements are only suitable for banners having a predetermined thickness.

### OBJECT OF THE INVENTION

The present invention aims at obviating the aforementioned disadvantages of previously known display systems, and at providing an improved display system arrangement. A primary object of the present invention is to provide an improved display system arrangement of the initially defined type which is structured to ensure easy mounting and dismounting of a sheet of material. It is another object of the present invention to provide a display system arrangement, in which the mounting and dismounting of a sheet of material does not need any tools. It is another object of the present invention to provide a display system arrangement which may be used for a wide range of sheet of materials, independent of the material, surface structure, thickness, etc.

### SUMMARY OF THE INVENTION

According to the invention at least the primary object is attained by means of the initially defined display system arrangement and display system having the features defined in the independent claims. Preferred embodiments of the present invention are further defined in the dependent claims.

According to a first aspect of the present invention, there is provided a display system arrangement of the initially defined type, which is characterized in that the display system arrangement comprises at least one locking clip insertable in said channel between the second surface of the channel and the second surface of the retainer profile, and that the locking clip comprises spring means, which when inserted exert pressure in the transverse direction against said second surface of the channel and said second surface of the retainer profile. According to a second aspect of the present invention, there is provided a display system according to claim 7.

Thus, the present invention is based on the insight that the use of a locking clip equipped with a spring exerts adequate pressure for retaining the sheet of material, independent of the thickness, surface structure, and material of the sheet of material.

In a preferred embodiment of the present invention, the locking clip comprises a carrier, which accommodate the spring means and which when inserted abut the second surface of the channel and of the retainer profile. This means that the spring means does not wear against the support profile of the retainer profile and that the carrier can be made of a material which has low friction against the second surface of the support profile and the retainer profile.

According to a preferred embodiment, the carrier has a height, when not inserted that is larger than the distance between the second surface of the retainer profile and the second surface of the channel, preferably 20-40% larger. Thereby the locking clip will exert a pressure to the retaining interface capable of withstanding a pulling force corresponding to at least 4 kg in the sheet of material.

### BRIEF DESCRIPTION OF THE DRAWINGS

A more complete understanding of the abovementioned and other features and advantages of the present invention will be apparent from the other dependent claims as well as from the following detailed description of preferred embodiments in conjunction with the appended drawings, wherein:

FIG. 1 is an exploded cross sectional side view of a first embodiment of the inventive display system arrangement,

FIG. 2 is an exploded cross sectional side view of a second embodiment of the inventive display system arrangement,

FIG. 3 is a side view of the first embodiment of the inventive display system arrangement in a mounted state,

FIG. 4 is a schematic side view of the inventive display system,

FIG. 5 is a perspective view from below of a support profile, a retainer profile and a banner,

FIG. 6 is a side view of a preferred embodiment of a locking clip,

FIG. 7 is a perspective view from above of the locking clip according to FIG. 6,

FIG. 8 is a perspective view from above of the locking clip according to FIG. 7, taken in a different angle,

FIG. 9 is a schematic side view of a second embodiment of the locking clip, and

FIG. 10 is a schematic cross sectional view of a display system arrangement according to prior art.

### DETAILED DESCRIPTION OF PREFERRED EMBODIMENTS OF THE INVENTION

The inventive display system may be any conceivable display system capable of retaining and displaying a sheet of material, such as a banner, poster, print, or the like, which may be made of a laminated sheet of material, a cardboard or paper sheet of material, or a flexible sheet of material made by fabric or vinyl, etc. In addition the sheet of material may have an even or a rough surface structure. Preferably the inventive display system is a portable display system for communicating a message or an advertisement on a fair, exhibition, lesson, in a shop, or the like.

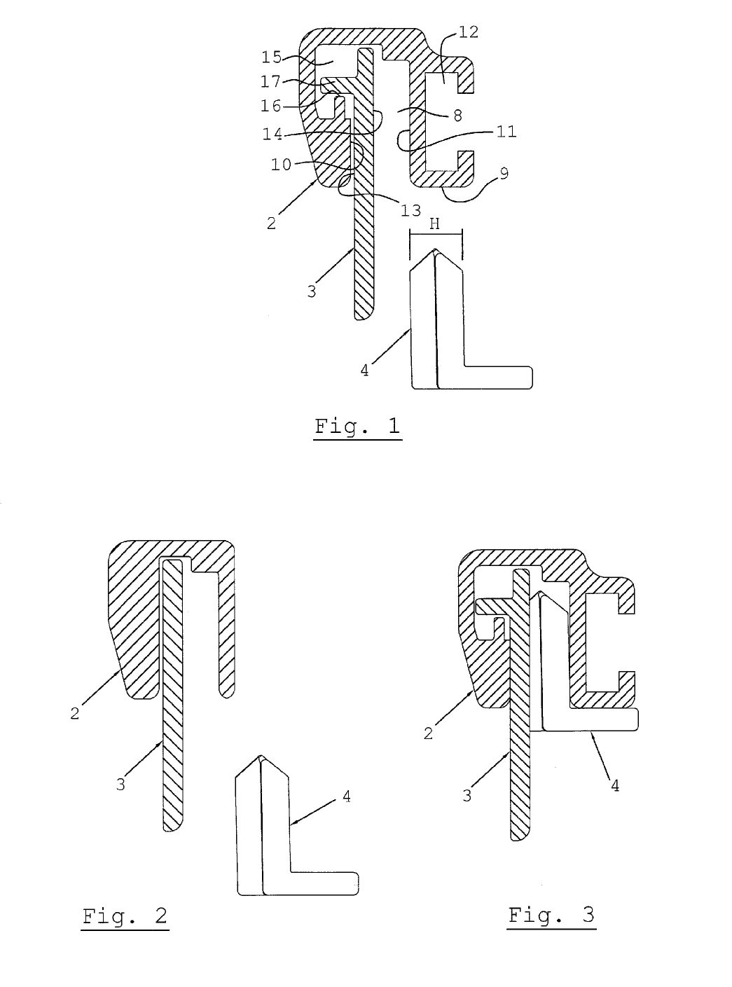

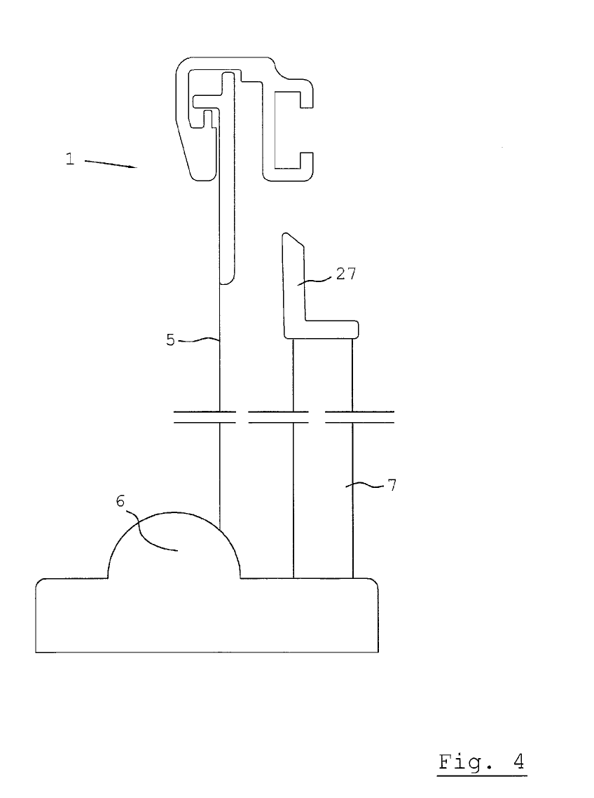

Reference is now made to FIGS. 1 and 2, which show a first and a second embodiment, respectively, of an inventive display system arrangement, generally designated 1. The display system arrangement 1 comprises an elongated support profile, generally designated 2, at least one retainer profile 3 and at least one locking clip, generally designated 4. In FIG. 3 the inventive display system arrangement 1 according to the preferred first embodiment is shown in a mounted state.

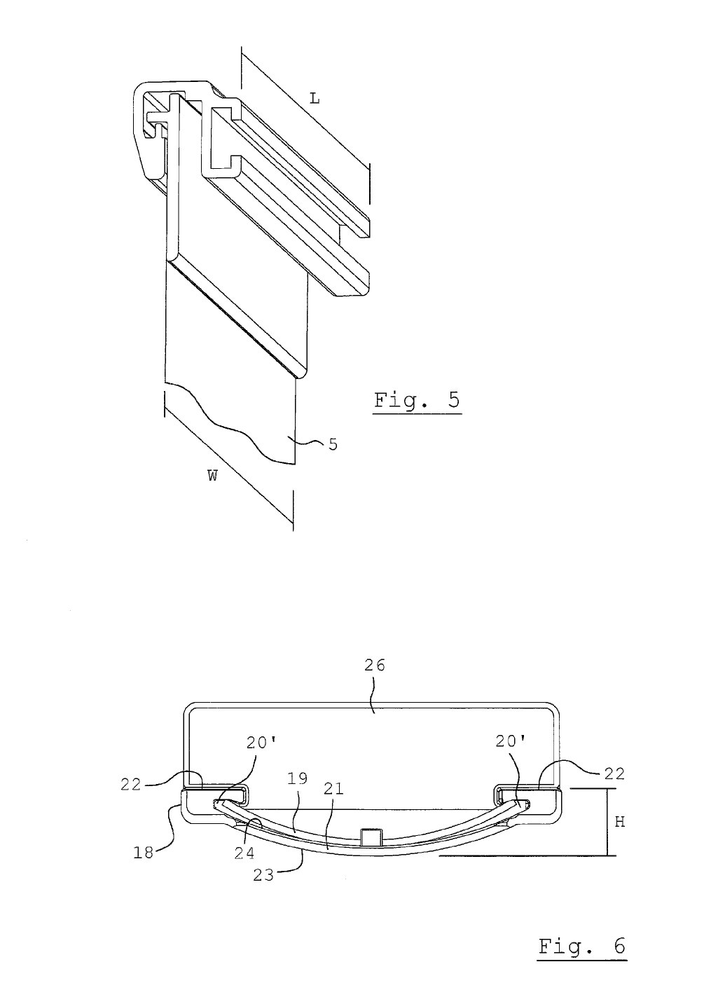

Reference is now also made to FIG. 4. The display system arrangement 1 is in principal arranged to constitute a top profile of a display system, schematically shown in FIG. 4, such as a banner stand or a roll up, even though the inventive display system arrangement 1 may as well be used as a bottom profile and/or a side profile. In rough outlines, the display system also comprises a banner 5, a suitable stand 6 as well as a supporting rod 7 extending between the stand 6 and the display system arrangement 1, in order to support the display system arrangement 1 and tightening the banner 5. However, it is essential for the present invention that the display system comprises at least an inventive display system arrangement 1 and a banner 5. Preferably the length L of the support profile 2 in the axial direction is more or less equal to the width W of the banner 5, see FIG. 5. The length L of the display system arrangement 1 according to FIG. 5 is made much shorter than usually utilized, for the sake of clarity. The inventive display system arrangement 1 is capable of retaining a banner 5 pulling with a force corresponding to at least 4 kg in the radial direction, said force originating from gravity and/or a spring, etc.

The support profile 2 comprises a longitudinal channel 8, which is open towards a lower side 9 of the support profile 2. Preferably, said longitudinal channel 8 is open towards at least one of the two ends of the elongated support profile 2. The channel 8 present a first surface 10 and a the first surface 10 opposite second surface 11. Said first surface 10 and said second surface 11 are preferably parallel to each other, or may converge downwards in order to retain the banner 5 with a higher force the heavier banner 5. It should be pointed out that the first surface 10 of the channel 8 may be provided with axially extending ribs (not shown) projecting towards the second surface 11 of the channel 8.

The at least one retainer profile 3 comprises a first surface 13 and a the first surface 13 reverse second surface 14. The retainer profile 3 is insertable the channel 8 of the support profile 2, in the axial direction and/or the radial direction. When mounted the first surface 13 of the retainer profile 3 is facing the first surface 10 of the channel 8, which together forms a retaining interface arranged to clamp the banner 5. Thereto, the second surface 14 of the retainer profile 3 is facing the second surface 11 of the channel 8. Preferably, the second surface 14 of the retainer profile 3 is in parallel with the second surface 11 of the channel 8.

In the embodiment according to FIG. 1, the support profile 2 comprises a slot 12, which may be used to attach a spotlight or the like to the display system. In addition, the channel 8 comprises a longitudinal radial recess 15 having a lower abutment surface 16 extending at an angle towards the first surface 10 of the channel 8, preferably perpendicular to said first surface 10. Thereto, the retainer profile 3 comprises a radial flange 17, which is arranged to extend into the radial recess 15 of the channel 8 and abut the abutment surface 16 during mounting of the display system arrangement 1. It should be pointed out that the retainer profile 3 according to FIG. 1 most be inserted into the channel 8 in the axial direction of the support profile 2, and is prevented from escaping the channel 8 in the radial direction.

Before the retainer profile 3 is inserted into the channel 8 of the support profile 2, the banner 5 is in the preferred embodiment attached to the first side 13 of the retainer profile 3 by means of an adhesive, such as a double-sided tape (not shown). In order to attach the banner 5 in a straight manner, the top edge of the banner 5 is arranged in parallel with the radial flange 17 of the retainer profile 3. It should be pointed out that the banner 5 may be attached to the first surface 10 of the channel 8 of the support profile 2 before insertion of the retainer profile 3, even thus not preferred. Thereto, the first surface 13 of the retainer profile 3 may be provided with axially extending ribs (not shown) projecting towards the first surface 10 of the channel 8, arranged to engage corresponding ribs provided on the first surface 10 of the channel 8.

It should be pointed out that the length of the retainer profile 3 in the axial direction is preferably more or less equal to the width W of the banner 5. However, two or more aligned retainer profiles 3 may be used, the total length of which is equal to or less than the width W of the banner 5.

The support profile 2 and the retainer profile 3 are preferably made of aluminium or the like, which material is light, deformation resistant and easy to extrude. However, the retainer profile 3 may as well be made of plastic or the like.

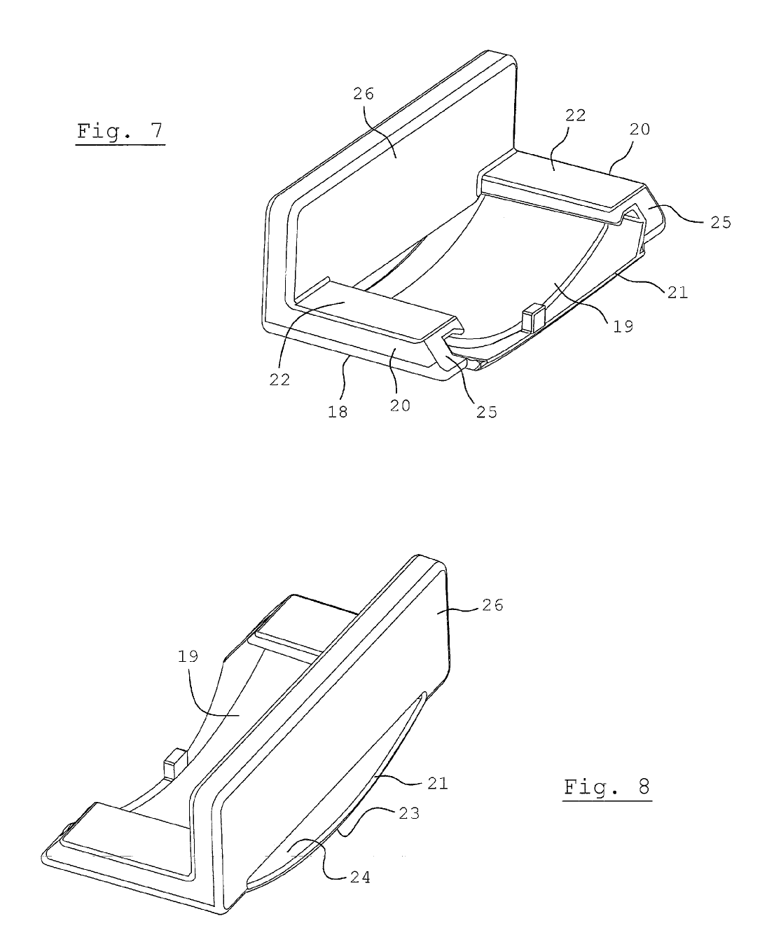

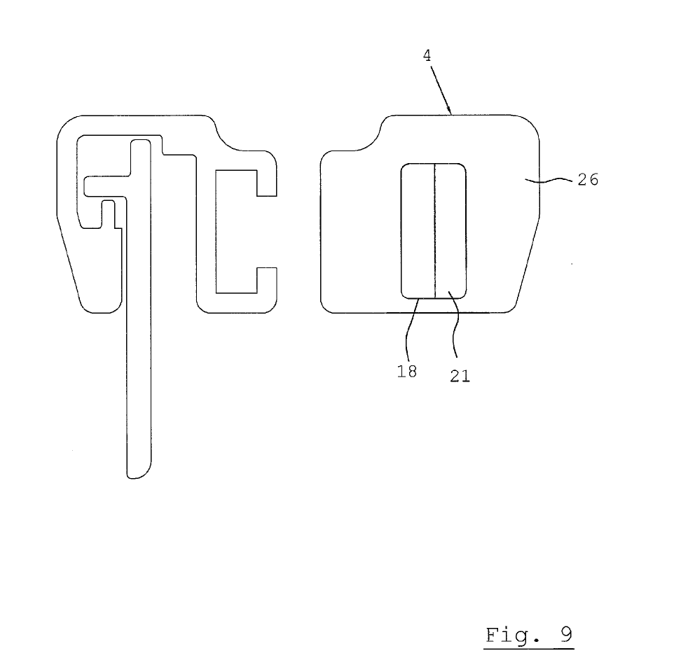

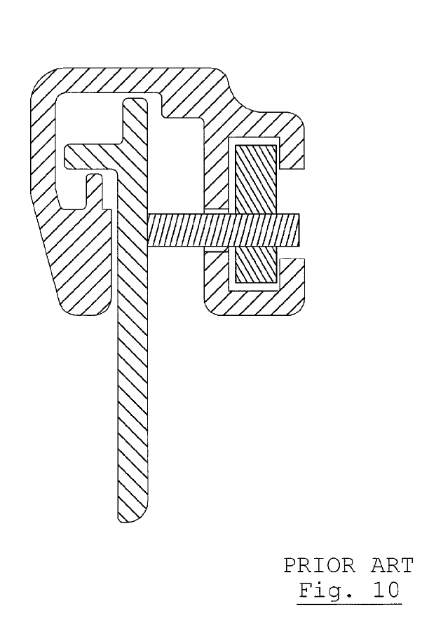

Reference is now made to FIGS. 6-8, which show the locking clip 4, which is the most essential component of the invention.

The locking clip 4 comprises a carrier 18 and a spring means 19, which is accommodated in said carrier 18. It should be pointed out that the carrier and the spring means may be one and the same component capable of exerting pressure against the second surface 11 of the channel and the second surface 14 of the retainer profile 3, in order to clamp the banner 5 in the retaining interface. In the preferred embodiment, the carrier 18 is made of plastic and the spring means 19 is an arched leaf spring, made of metall. The carrier 18 has a height H, taken in a the support profile 2 transverse direction, which in the not inserted state is larger than the distance between the second surface 14 of the retainer profile 3 and the second surface 11 of the channel 8 of the support profile 2, preferably 20-40% larger. The spring means 19 is in the shown embodiment arranged not to abut or contact the support profile 2 or the retainer profile 3, in order not to wear against them. The carrier 18 comprises, in the shown embodiment, two end holders 20 and a the two end holders 20 interconnecting bridge 21, which is arranged to deform, in a the support profile 2 transverse direction, in order to lower the height H of the carrier 18 when inserted. Each of the end holders 20 presents a abutment surface 22, which are arranged to abut the second surface 11 of the channel 8, and the bridge 21 presents an abutment surface 23, which is arranged to abut the second surface 14 of the retainer profile 3. The two ends of the arched leaf spring 19 are located in grooves 20′ of the end holders 20 of the carrier 18 and at least the lowest point of the arched leaf spring 19 abuts an upper surface 24 of the bridge 21. The leading edge 25 of each end holder 20 is tapered towards the bridge 21, in order to facilitate the insertion of the locking clip 4 in the channel 8. In addition, the leading edge of the bridge 19 may be tapered in the opposite direction.

Preferably the locking clip 4 comprises a stop flange 26, which is arranged to abut the lower side 9 of the support profile 2 when the locking clip 4 is inserted in the channel 8. When the stop flange 26 abuts the lower side 9 of the support profile 2, it gives the operator an indication that the locking clip 4 is properly inserted. The stop flange 26 preferably rigidly interconnects the end holders 20 in order to enhance the spring force of the locking clip 4. The insertable length of the carrier 18, taken in a the support profile 2 radial direction, is larger than the distance between the second surface 14 of the retainer profile 3 and the second surface 11 of the channel 8 of the support profile 2, preferably 2-3 times larger.

Reference is now made to FIG. 9, in which is shown an alternative embodiment on the locking clip 4. The shown locking clip 4 is arranged to be inserted in the axial direction of the support profile 2, and the stop flange 26 has preferably an outer contour corresponding to the outer contour of the support profile 2. In another alternative embodiment (not shown) the locking clip 4 according to FIGS. 6-8, may be arranged with the stop flange 26 of the locking clip 4 according to FIG. 9, which is then connected to one of the end holders 20 of the locking clip 4 according to FIGS. 6-8.

Reference is now made to FIG. 4. The supporting rod 7 comprises in the upper end an attachment means 27 arranged to support the inventive display system arrangement 1. The attachment means 27 is preferably insertable in the channel 8, and may be designed as a locking clip 4.

### Feasible Modifications of the Invention

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the display system arrangement may be modified in all kinds of ways within the scope of the appended claims.

For instance, it shall be pointed out that the spring means not necessarily needs to be an arched leaf spring, but any means capable of exerting pressure in the transverse direction against the second surface of the channel and the second surface of the retainer profile may be used. Thus, any spring means having a low height may be used, or the carrier of the locking clip itself can be design as a spring means.

It shall also be pointed out that all information about/concerning terms such as above, below, under, upper, etc., shall be interpreted/read having the equipment oriented according to the figures, having the drawings oriented such that the references can be properly read. Thus, such terms only indicates mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

The invention is not limited to the embodiment/s illustrated in the drawings. Accordingly it should be understood that where features mentioned in the appended claims are followed be reference signs, such signs are included solely for the purpose of enhancing the intelligibility of the claims and are in no way limiting on the scope of the claims.

1. A display system arrangement for retaining a sheet of material, comprising an elongated support profile (2) and at least one retainer profile (3), the support profile (2) comprises a longitudinal channel (8), which is open at least towards a lower side of the support profile (9) and which presents a first surface (10) and an opposite second surface (11), the at least one retainer profile (3) being insertable in said channel (8) in order to form a retaining interface between said first surface (10) of the channel (8) and a first surface (13) of the retainer profile (3), the retainer profile (3) comprising a reverse second surface (14), characterized in that the display system arrangement comprises at least one locking clip (4) insertable in said channel (8) between the second surface (11) of the channel (8) and the second surface (14) of the retainer profile (3), and that the locking clip (4) comprises spring means (19), which when inserted exert pressure in the transverse direction against said second surface (11) of the channel (8) and said second surface (14) of the retainer profile (3).

2. The display system arrangement according to claim 1, wherein the locking clip (4) comprises a carrier (18), which accommodates the spring means (19) and which when inserted abuts the second surface (11) of the channel (8) and the second surface (14) of the retainer profile (3).

3. The display system arrangement according to claim 2, wherein the carrier (18) comprises two end holders (20) and an interconnecting bridge (21).

4. The display system arrangement according to claim 2, wherein the carrier (18) has a height (H), taken in a the support profile (2) transverse direction, which in the not inserted state is larger than the distance between the second surface (14) of the retainer profile (3) and the second surface (11) of the channel (8) of the support profile (2), preferably 20-40% larger.

5. The display system arrangement according to claim 1, wherein the spring means (19) is an arched leaf spring.

6. The display system arrangement according to claim 1, wherein the locking clip (4) comprises a stop flange (26) arranged to abut the lower side (9) of the support profile (2).

7. A display system for displaying a message of a sheet of material, characterized in that the display system comprises a display system arrangement according to claim 1 and a sheet of material (5) retained in said display system arrangement.
